(19) United States
(12) Patent Application Publication
(10) Pub. No.: US 2004/0140041 A1
(43) Pub. Date: Jul. 22, 2004

(54) Geotextile tube repair, construction and reinforcement method and apparatus

(76) Inventor: Scott Glick, Clute, TX (US)

Correspondence Address: HAYNES AND BOONE, LLP, 901 MAIN STREET, SUITE 3100, DALLAS, TX, 75202, US

(21) Appl. No.: 10/747,347

(22) Filed: Dec. 29, 2003

Related U.S. Application Data
(60) Provisional application No. 60/436,700, filed on Dec. 27, 2002.
(60) Provisional application No. 60/439,778, filed on Jan. 13, 2003.

(51) Int. Cl. B32B 35/00

(52) U.S. Cl. 156/94; 427/140

(57) ABSTRACT

A method and apparatus for repair, protection, reinforcement, modification, construction or preventative maintenance of geotextile tubes by applying a reinforcing material is provided.

### RELATED APPLICATIONS

The present application claims the benefit of U.S. provisional application Serial No. 60/436,700, Attorney Docket No. 33385.3, filed Dec. 27, 2002 and U.S. provisional application Serial No. 60/439,778, Attorney Docket No. 33385.4, filed Jan. 13, 2003, both incorporated herein by reference and relied upon for priority.

### TECHNICAL FIELD

The present disclosure relates to repair, protection, reinforcement, modification, construction or preventative maintenance of geotextile tubes and associated ultraviolet (UV) shrouds and scour aprons.

### BACKGROUND INFORMATION

Geotextile tubes are elongated flexible tubes, typically made of woven and non-woven polymeric materials formed into a tubular shape that is filled with sand or other material. For example, a slurry of a solid material and a liquid carrier, such as a slurry of sand and water, may be injected into an open end of the tube, or into fill ports formed along the length of the tube. The water escapes through the pores of the material and open fill ports and the sand is retained within the tube. The ends of the geotextile tube, and the fill ports along the tube (if any), are closed and the sand remains inside the tube to effectively form a very long tubular shaped “sand bag.” The geotextile tubes can be several centimeters (several inches) in diameter up to several meters (several yards) in diameter. Geotextile tubes may, for example, be installed along beachfronts or other waterways and positioned to retain the beach or bank and to reduce and prevent erosion. Particularly, geotextile tubes are used along beaches where beach front housing is built or along natural environmental habitats to prevent the erosion of the beach that can on occasion cause the entire profile of the beach to be changed over time and may result in the loss of valuable real estate property or the destruction of habitats for wildlife. Other uses include sludge or industrial waste filtering, containment and dewatering.

### BRIEF DESCRIPTION OF THE DRAWINGS

FIG. 1 is a perspective view of a geotextile tube;

FIG. 2 is a partial schematic depiction of a damaged geotextile tube;

FIG. 3 is a partial schematic depiction of the damaged geotextile tube of FIG. 2 in the process of applying a reinforcing material;

FIG. 4 is a partial schematic depiction of a repaired geotextile tube of FIGS. 2 and 3 after application of a reinforcing material;

FIG. 5 is a partial schematic depiction of a repaired geotextile tube of FIGS. 2, 3 and 4 after application of a reinforcing material, and further including the application of a patch material;

FIG. 6 is a schematic cross-sectional view of a geotextile tube with a UV protection shroud, depicting one side of the UV protection shroud sealed and secured to the geotextile tube with a reinforcing material;

FIG. 7 is a schematic cross-sectional view of a geotextile tube with a protective and reinforcing coating applied to an exposed surface of the geotextile tube with a reinforcing material;

FIG. 8 is a schematic cross-sectional depiction a geotextile tube including a filling port and secured to the geotextile tube;

FIG. 9 is a schematic cross-sectional view of the geotextile tube of FIG. 8 with the filling port sealed closed by applying a reinforcing material, which forms a coating after the geotextile tube is filled with sand and the port is closed; and

FIG. 10 is a schematic cross-sectional view of the geotextile tube of FIGS. 8 and 9 with the filling port sealed closed by applying a reinforcing material, an overlaying patch of material and an additional coating layer of reinforcing material after the geotextile tube is filled with sand and the port is closed. Detailed Description of the Illustrative Embodiments

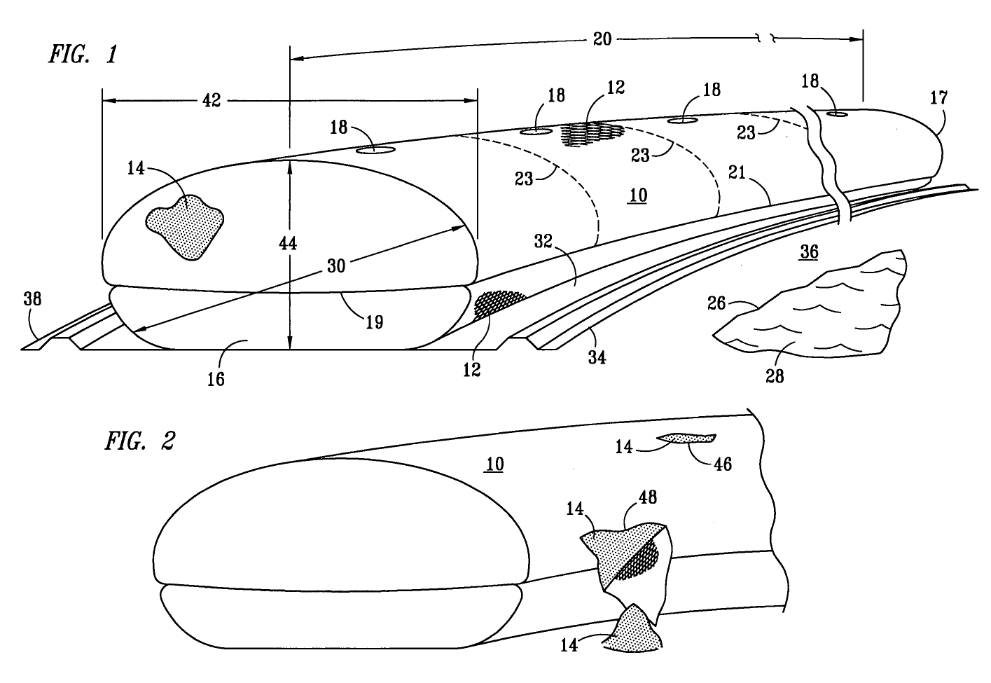

Referring to FIG. 1, which is a perspective view of a geotextile tube 10 of the type for application of the disclosed method of repair, reinforcement, modification, construction or protection, it can be seen that geotextile tube 10 is an elongated flexible tube made of woven polymeric fabric material 12. For example, polyester multifilament yarn or polypropylene multifilament yarn forms the fabric 12. The geotextile tube 10 is filled with sand 14. For example, sand is injected as a slurry of sand and water into one end 16 of the tube 10. Another end 17 of the geotextile tube 10 is closed before the tube 10 is filled with sand 14. The fill end 16 is closed, for example, along a seam 19 after the geotextile tube 10 is filled with sand 14 or soil or other solid particulate material. The geotextile tube 10 is shown constructed form pieces of fabric joined together at lateral seams 21 and at circumferential seams 23. In one alternative construction, both ends 16 and 17 are closed and a slurry of sand and water is injected into fill ports 18 formed along the length 20 of the geotextile tube 0.10. The water escapes through the pores of the fabric 12 and the sand is retained within the geotextile tube 10. The ports 18 are closed and the sand 14 remains inside the geotextile tube 10 to effectively form a very long tubular shaped “sand bag.” Conventional geotextiles are available from commercial suppliers, such as, for example, Ten Cate Nicolon by of the Netherlands, which produces geotextiles made of polypropylene (PP), polyethylene (PE) and polyester (PET).

Geotextiles may be of a woven or nonwoven material. Nonwoven geotextiles may be, for example, made from polypropylene and may be manufactured using needle punched, staple fibre technology. Woven Geotextile may be, for example, a planar textile structure produced by interlacing two or more sets of elements, such as yarns, fibers, rovings, or filaments, where the elements pass each other, usually at right angles, and one set of elements are parallel to the fabric axis.

A geotextile tube 10 is shown installed along a beachfront 26 or other waterways and positioned adjacent to a body of water 28 to retain the beach or bank and to reduce and prevent erosion due to the wash of waves or other flow of water 28. For the purpose of reducing or preventing erosion along the beachfront 26, the geotextile tube 10 may have, for example, a length 20 of more than about one hundred meters long (several hundred feet long) and a cross sectional dimension 30, or a “diameter” 30, of up to three to five meters (about 9 to 15 feet) or more. For example, a geotextile tube 10 may be placed along a residential or resort beach location where beachfront housing is built or along a natural environmental habitat to prevent the erosion of the beach and the loss of valuable real estate property or the destruction of a habitat for wildlife. However, the geotextile tube can be any size. Another typical size for a geotextile tube 50 used in an anti-erosion application may be, for example, one hundred meters long with a circumference of ten meters.

The geotextile tube 10 is shown installed secured to, and on top of, a scour apron 32 that extends to a front edge 34 on the sand 36 of the beachfront 26 toward the water 28 and may extend several feet to a rear edge 38 inland from the geotextile tube 10. The apron 32 helps to maintain the geotextile tube 10 in the desired location as sand and soil accumulates on the edges 34 and 38 of the apron 32. This can help prevent the geotextile tube 10 from rolling. Rolling is also resisted because the geotextile tube 10 naturally forms in an oval or flattened shape, rather than perfectly cylindrical, due to the forces of gravity on the sand 12 contained within the geotextile tube and the flexibility of the fabric material 12. Thus, as an example only, a geotextile tube 10 is shown that is about 3 to 4 meters (9 to 12 feet) wide, as at 42, and only about 2 to 2.5 meters (5 to 6 feet) tall, as at 44.

Other uses of geotextile tubes include dewatering of sludge or other industrial waste in which case the geotextile tube is laid out in an appropriate area for water bearing sludge to by pumped into the geotextile tube so that the solid material are filtered out of the water and retained for proper disposal in the tube and the water escapes through the walls of the tube for further purification or discharge.

It has been found that although the geotextile tubes are very strong against pressure, biological degradation and natural water abrasion forces, they are susceptible to damage from other factors such as, but not limited to, UV degradation, floating or wind driven objects, animal or human activities any of which may abrade, cut or tear the geotube, scorn pad or UV shroud fabric. In areas of heavy human traffic, the geotextile tubes are often damaged by wear and by tears. For example, sharp object tears may result either from inadvertent damage caused by the heals of shoes, walking sticks and the like or from acts of vandalism with knives or purposeful destructive use of sharpened objects. The outward pressure of the contained sand 14, particularly when the sand is saturated with water, exacerbates the ripping, tearing or rupture of the damaged polymeric fabric 12 of the geotextile tube 10.

One embodiment of the method of repair may be better understood with reference to FIGS. 2, 3 and 4. Reinforcing material 50, is applied to repair cuts and tears in geotextile tubes and in shrouds and scour aprons formed of the same woven polymers as the geotextile tube. The reinforcing material 50 is capable of adhering to the material to be repaired or curing in a wet environment, so that it may be deposited directly onto the woven textile fabric even when it is damp or wet and create a seal sufficient to repair the cut or tears. An example of such a material is Polyurea distributed by Versaflex Incorporated of Kansas City, Kans.

As will be recognized by persons having ordinary skill in the art, a polyurea coating/elastomer typically is derived from the reaction product of an isocyanate component and a resin blend component. The isocyanate can be aromatic or aliphatic in nature. The Isocyanate can be, for example, monomer, polymer, any variant reaction of isocyanates, quasi-prepolymer or a prepolymer. The prepolymer, or quasi-prepolymer, can be, for example, made of an amine-terminated polymer resin, or a hydroxyl-terminated polymer resin. The resin blend typically is made up of amine-terminated polymer resins, and/or amine-terminated chain extenders. The amine-terminated polymer resins typically will not have any intentional hydroxyl moieties. Any hydroxyls are typically the result of incomplete conversion to the amine-terminated polymer resins. The resin blend, for example, may also contain additives, or non-primary components. These additives, for example, may contain hydroxyls, such as pre-dispersed pigments in a polyol carrier. Normally, the resin blend will not contain a catalyst(s).

As geotextile tubes are typically made of either polyester multifilament yarn or polypropylene multifilament yarn and the polyurea reinforcing material is a resulting elastomer product of an isocyanate component and a resin component, the bond between the geotextile fabric and the polyurea coating is strong. Small cuts and tears can be repaired by directly spraying polyurea directly to the cut area and letting it cure (usually only a few seconds are required for hardening). In instances where the tear is longer or irregular, the effected area is pulled together and or reinforced with a patch of similar material held mechanically in place with staples, nails, and/or stitching with polyester, cotton or nylon thread. Then, the entire area, or at least the seam area, is sprayed with polyurea to form a permanently bonded repair.

In FIG. 2, a damaged geotextile tube 10 is shown having a small tear 46 and a larger rip 48. Repairing a geotextile tube once it is ripped open has been very difficult and problematic. The traditional approach has been to mechanically stitch together any tears or rips and then to mechanically secure a patch or covering of the same geotextile fabric material over the stitched together tear or rip. By the time the damage is discovered, the tear or rip may have become a very large hole and a portion of the sand 14, previously contained within the tube 10, will have escaped or eroded out of the tube 10 in the area of the damage. Thus, a process of mechanically stitching the tears or rips, while also attempting to refill the tube 10 with sand 14, has not been entirely satisfactory. Moreover, the dirty and wet environment, in which the geotextile tubes are placed, has made many attempts to adhere a patch of similar woven geotextile fabric over the damaged area generally unsuccessful. Replacement of an entire geotextile tube 10, that may be hundreds of meters long, is expensive and often difficult after the geotextile tube 10 has been in place for some time and has accumulated sand and soil along its length.

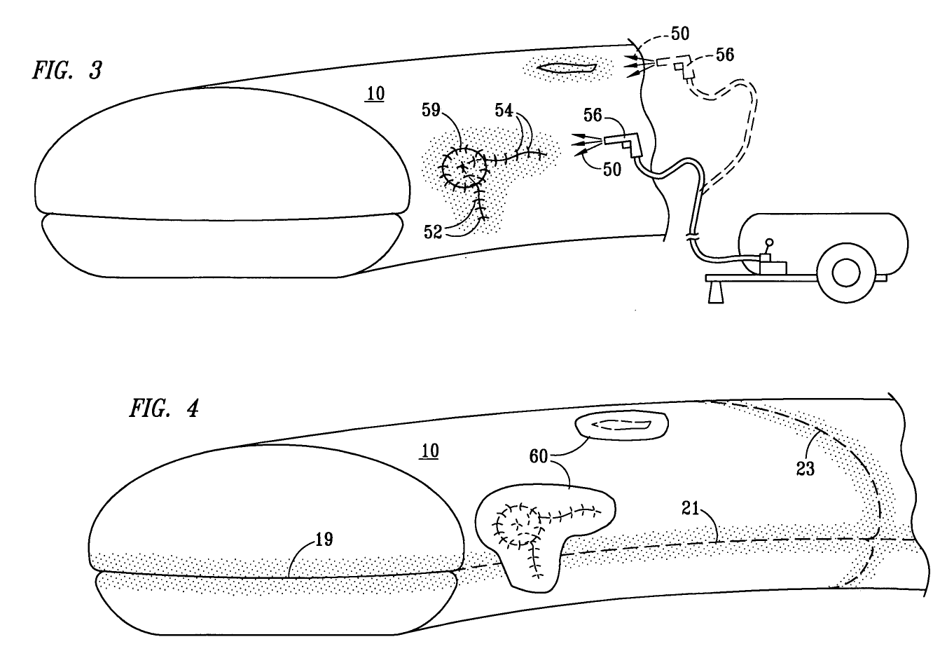

FIG. 3 shows a damaged geotextile tube 10, having a reinforcing material 50 applied according to a process of one embodiment. The reinforcing material 50, is a polyurea material applied as a liquid to the geotextile tube 10. In alternative embodiments, the reinforcing material may be selected from among a group comprising polyurea, polyurea hybrids, polyurethane, polyurethane hybrids and combinations thereof. The process includes applying the reinforcing material 50 onto a damaged area or onto any area where reinforcement is desired. For example, as shown in FIG. 3, the reinforcing material 50 is applied to a damaged area, such as the area surrounding the small tear 46 or the larger rip 48. The process may also include mechanically holding the edges of the tear 46 or rip 48 together. For example the large rip 48 is shown mechanically held together with staples 52 and/or thread 54 and the reinforcing material 50 is applied over the surrounding area with a spray nozzle 56. A patch 59 of fabric material may also be applied to replace underlying fabric material 12 in the area to be repaired. The applied reinforcing material 50 cures over the rip 48 or tear 46, and over the patch 59 if used, thereby repairing the damaged geotextile tube 10. In one embodiment the reinforcing material 50 may be applied appropriately mixed so that curing occurs after spraying directly onto the polymeric fabric material 12 of he geotextile tube 10.

A primer material may also be applied with the reinforcing material 50, which may further facilitate adhesion and curing. The primer 51 may be applied directly to the fabric material of the geotextile tube 10 at the area of application of the reinforcing material 50. In one embodiment, the primer 51 is a single component modified isocyanate. One example of such a primer material is a product known as PW1 available from Versaflex Incorporated of Kansas City, Kans.

FIG. 4 is a partial schematic depiction of a repaired geotextile tube of FIGS. 2 and 3 after application of reinforcing material 50 and curing of the reinforcing material 50 into a coating 60 according to one aspect of the present inventive method and system for repairing the tears 46 and rips 48 of the geotextile tube 10.

It will be understood, that according to another embodiment, reinforcing material 50, with or without a primer material 51, may be sprayed to repair or reinforce and facilitate sealing of any seams in the geotextile tube 10 that may pull apart during use, or to construct strong seams that will resist pulling apart upon installation. Thus, it is understood that, where end closing seams 19 or circumferential seams 21 might also be present in the construction of geotextile tubes 10, applying the reinforcing material 50 onto the seams 19 and 21 may facilitate sealing, reinforcement, construction or repair of such seams.

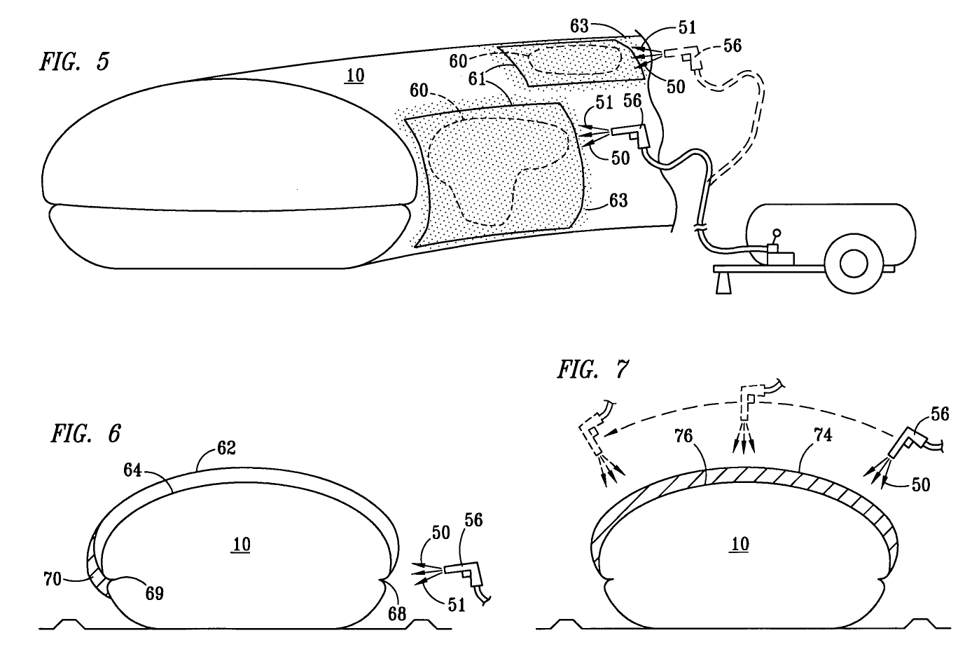

As shown in FIG. 5, according to another embodiment, a cover patch 61, such as a polymeric fabric similar to the material forming the geotextile tube 10, may also be placed either inside or outside of the geotextile tube 10 to overlap the tear. A first layer of reinforcing material 50 is applied, then the patch 61 is placed on the reinforcing material. Again the application of reinforcing material 50 may also include application of a primer 51, which may facilitate adhesion or curing or both. According to one embodiment, the patch 61 is applied before the reinforcing material 50 fully cures. The patch 61 may be worked or kneaded into the applied reinforcing material 50. Another layer of reinforcing material 50 sprayed over the patch 61, further reinforces and smoothes the edges and the overall appearance of the repaired or reinforced area. Thus, the patch 61 may be sprayed with the reinforcing material 50 and allowed to cure to form a binding coating 63 to cover the repair area and to hold the patch 61 securely in place thereby effecting an extra strong repair.

With reference to FIG. 6, it will be understood that degradation of the geotextile tube 10 is reduced using a UV protective shroud 62 to an upper surface 64 of the geotextile tube 10, where it is most directly exposed to sunlight. Such a UV shroud 62 is made of a flexible sheet material including extra UV protective components. The UV shroud 62 can also slow the wearing effects of heavy human traffic, as when the geotextile tube 10 is traversed by people moving to and from a beach or waterway that is being protected by the geotextile tube 10. Conventional UV shrouds are available from commercial suppliers, such as, for example, Ten Cate Nicolon by of the Netherlands.

Seams at 68 and 69 are shown for securing or otherwise bonding the UV protective shroud 62 to the geotextile tube 10. The reinforcing material 50, is applied to facilitate the bonding. Again the reinforcing material 50 may be a polyurea material. In alternative embodiments the reinforcing material may be selected from among a group comprising polyurea, polyurea hybrids, polyurethane, polyurethane hybrids and combinations thereof. Particularly in cases where UV protection is desired, the reinforcing material 50 selected above may also be specially formulated with appropriate pigments or other UV blockers to facilitate UV protection when applied. As will be discussed more fully below, the UV enhanced reinforcing material 50 may be applied either with or without a UV protective shroud 62. Conventional UV blockers are available from commercial suppliers, such as, for example, Versaflex Incorporated of Kansas City, Kans. Thus, a UV shroud 62, when applied to a geotextile tube 10, can be secured in place using spray applied coatings, formed from a reinforcing material 50, at selected locations or along the entire length. In FIG. 6 a schematic cross-sectional view of a geotextile tube 10 is shown with a UV protection shroud 62 covering a top surface 64 of the geotextile tube 10. The UV protection shroud 62 may be secured along a seam 68 along the length of geotextile tube 10. As depicted, such a seam 68 may be sprayed with the reinforcing material 50 to form a sealed and reinforced seam covering coating 70. Again the reinforcing material 50 may be applied with or without a primer 51, similar to the process described above in connection with the repair of tears and rips. The spray process at 50 is shown on one side of the geotextile tube 10 and the resulting seam reinforcing coating 70 is depicted on the other side of geotextile tube 10. Thus, the shroud 62 is sealed and secured to the geotextile tube 10 with a coating 70 formed along seam 69. It will be understood that although seam 68 is shown at the other side of the geotextile tube 10, in the process of being secured and sealed with the reinforcing material 50, the process will result in a coating similar to that shown at 70.

FIG. 7 shows a geotextile tube 10 with a protective and reinforcing coating 74 applied to an exposed surface 76. A reinforcing material 50 has been applied to form a coating along the entire length of the geotextile tube 10. Thus, areas of a geotextile tube 10 at which heavy traffic might be expected, can be constructed, filled with sand and then reinforced over the exposed surface 76 with a coating 74 formed by spraying reinforcing material 50 onto the formed and filled geotextile tube 10. This same application, either using a normal formulation of reinforcing material 50 or using a specially enhanced UV resistant or UV blocking formulation, creates an additional UV resistant covering, which may be applied to new or existing geotextile tubes. In such instances, even though the top, or exposed surface 76, to which the reinforcing material 50 is applied, could become less permeable to water, the bottom 78 of the geotextile tube 10 remains water permeable so that the tube 10 continues to drain excess water as before. Reinforcing material 50 may be applied before or after the geotextile tube is filled with sand.

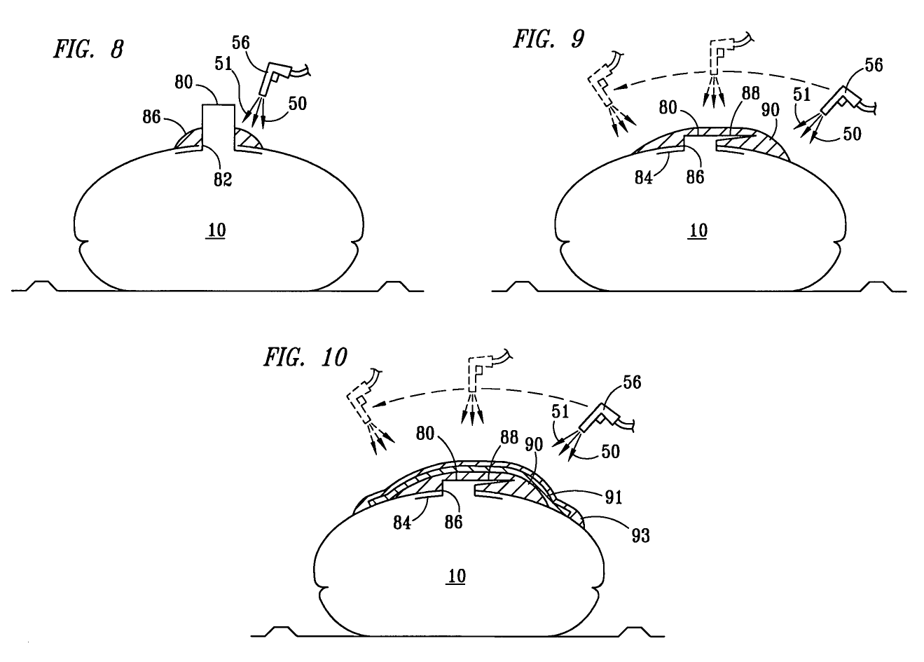

According to another embodiment, as may be seen in FIGS. 8 and 9, a reinforcing material 50 is applied to attach a new filling port 80 at a damaged area. Upon re-filling the geotextile tube 10 with sand, the filling port 80 may be closed by spraying over it with the reinforcing material 50. Again the reinforcement material 50 may be applied directly or with a primer 51. The geotextile tube 10 is shown to be modified by adding a filling port 80 and by securing the port 80 to the geotextile tube 10 with reinforcing material 50. The port 80 is sealed and attached into an opening 82 in the geotextile tube 10. A coating 86 is formed by which the edges 84 of the inserted port 80 are bonded and sealed to the opening 82 with a coating of the reinforcing material 50.

FIG. 9 shows the geotextile tube 10 of FIG. 8 with a top flap 88 of filling port 80 is closed by bending the port 80 down after the geotextile tube 10 is filled or re-filled with sand. The port is sealed by applying reinforcing material 50. A coating 90 is formed over the closed filling port 80.

FIG. 10 shows a closed fill port 80 further reinforced with a cover patch 91 applied over the closed port 80 and a cover layer 93 is further formed covering the closed and sealed port.

In an alternate embodiment, reinforcing material 50 may be used during the geotextile tube 10 construction process to join lateral seams 21 together and circumferential seams 23 together. The reinforcing material 50 may be any type of material capable of bonding to the tube. For example, the reinforcing material 50 may be selected from among a group comprising polyurea, polyurea hybrids, polyurethane, polyurethane hybrids and combinations thereof.

In yet another alternate embodiment, reinforcing material 50 may be used during the geotextile tube 10 construction process to cover the entire geotextile tube 50. The reinforcing material 50 may be any type of material capable of bonding to the tube. For example, the reinforcing material 50 may be selected from among a group comprising polyurea, polyurea hybrids, polyurethane, polyurethane hybrids and combinations thereof.

It is understood that variations may be made in the foregoing without departing from the scope of the geotextile tube repair and reinforcement method and apparatus. For example, terms with directional connotations such as base, top, upper, lower, outer, and inner are used in context for purposes of relative positions and the device need not be limited to absolute directions in order to fall within the scope of the geotextile tube repair and reinforcement method and apparatus described and claimed. While various features and embodiments are described in certain combinations and sub-combinations selected features from one embodiment may be combined with features of other embodiments without departing from certain aspects of the geotextile tube repair and reinforcement method and apparatus.

The reinforcing material 50 is described in connection with a polyurea material. The polyurea material may be in the form of a mixture of two parts that are appropriately combined. It is also indicated that such reinforcing material may be selected from among a group comprising polyurea, polyurea hybrids, polyurethane, polyurethane hybrids and combinations thereof. The selected reinforcing material may also include mixtures or multipart combinations of such polyurea and polyurethane materials with pigments or other UV protection components.

The reinforcing material 50 is described in connection with a material applies as a liquid. In an alternative embodiment the material might be applied as a partially fluid material such as a paste.

While the applying of the reinforcing material has been described as a process of spraying the reinforcing material onto the geotextile tube, the reinforcing material might also be applied using other methods of applying liquids or paste such as pouring, brushing or spreading of the reinforcing material onto the geotextile tube.

In some instances the tears, rips or worn areas may be repaired with direct application of the reinforcing material. In alternative embodiments the damaged area, tears, rips or patches have been described as being held together mechanically with staples or stitches to facilitate repair with the application of the reinforcing material. Alternatively, patches may be applied to fill-in a hole or patches may be applied covering the entire damaged area. In all these instances, alternative methods and devices to hold the tears and rips together or to hold the patches in place for the application of the reinforcing material are contemplated.

According to one embodiment, polyurea is spray applied to repair cuts and tears in geotextile tubes and in shrouds and scour aprons formed of the same woven polymers as the geotextile tube. The polyurea material is hydrophobic so that it may be sprayed directly onto the woven textile fabric even when it is damp or wet. As geotextile tubes are typically made of either polyester multifilament yarn or polypropylene multifilament yarn and the polyurea reinforcing material is a resulting elastomer product of an isocyanate component and a resin component, the bond between the geotextile fabric and the polyurea coating is strong. Small cuts and tears can be repaired by directly spraying polyurea directly to the cut area and letting it cure (usually only a few seconds are required for hardening). In instances where the tear is longer or irregular, the effected area is pulled together and or reinforced with a patch of similar material held mechanically in place with staples, nails, and/or stitching with polyester, cotton or nylon thread. Then, the entire area, or at least the seam area, is sprayed with polyurea to form a permanently bonded repair.

According to another embodiment, UV shrouds, when applied can be secured in place using a reinforcing material, selected from among a group comprising polyurea, polyurea hybrids, polyurethane, polyurethane hybrids and combinations thereof, spray applied to form a coating along the entire length. This effectively forms a secure seam and bond between the geotextile tube and the UV protective shroud. The spray coating material may be a “normal” off the shelf formulation or it may be specially formulated with appropriate pigments or other UV blockers to facilitate UV protection when applied either with or without another UV shroud. The reinforcing material, either with or without UV protection, may also be used to replace the UV shroud entirely on an existing geotextile tube or it may be installed as a UV shroud during new construction.

According to another embodiment, a reinforcing material, selected from among a group comprising polyurea, polyurea hybrids, polyurethane, polyurethane hybrids and combinations thereof, is sprayed to repair or construct the seams in the geotextile tube that may pull apart or to construct seams upon installation that will resist pulling apart.

According to another embodiment, areas of a geotextile tube at which heavy traffic might be expected, can be constructed, filled with sand and then reinforced over the exposed surface with a coating of a reinforcing material before traffic or exposure to the elements. In such instances, even though the top, or exposed surface, to which the reinforcing material is applied, might become partially water impermeable, the bottom of the tube remains water permeable so that the tube continues to drain excess water as before. Reinforcing material 50 may be applied before or after the geotextile tube is filled with sand.

According to another embodiment, a reinforcing material is spray applied to create at a filling port at a damaged area such a filling port may be created using the same reinforcing material during manufacturing of the geotextile tube. The reinforcing material may be applied externally or internally around the base of the filling port. Upon re-filling the geotextile tube with sand, the filling port may be closed by applying the reinforcing material or using mechanical closure methods. Thus, the use of polyurea, polyurea hybrids, polyurethane, polyurethane hybrids and combinations thereof, as spray formed coatings for closing of filing ports may also be beneficially applied to new geotextile tubes, upon completion of the installation, to improve the sealing of the filling ports over methods and devices previously used.

In another embodiment, a geotextile tube is disclosed. The tube is elongated and flexible made of a material that is capable of being injected with a slurry of solid material and a liquid carrier, that will allow the liquid carrier to escape through the material leaving the solid material inside of the tube. A layer of reinforcing material on the exterior of the tube. The reinforcing material may be capable of bonding to the tube in the presence of moisture or be selected from among a group comprising polyurea, polyurea hybrids, polyurethane, polyurethane hybrids and combinations thereof. The reinforcing material may be located on top of a damage area of the tube, which may have been repaired by a mechanical mechanism prior to the application of the reinforcing material. The reinforcing material may also be located along a seam of the tube, which may been closed by a mechanical mechanism prior to the application of the reinforcing material. Example mechanical mechanisms may be selected from a group comprising staples, nails, and stitching. An example geotextile tube may at least one hundred (100) meters long and may have a cross sectional dimension of at least three meters. Also, a primer may be applied on to the tube prior to the reinforcing material, which may facilitate curing or bonding or both of the reinforcing material. Additionally, for UV protection, the reinforcing material may be used to secure a UV shroud to the tube or the reinforcing material may be formulated with pigments or other UV blockers to facilitate UV protection when applied.

In yet another embodiment, a method of preventing erosion of the earth surface is disclosed. The method comprises positioning an elongated flexible tube of a material of the earth surface, capable of being injected with a slurry of solid material and a liquid carrier, that will allow the liquid carrier to escape through the material leaving the solid material inside of the tube. Then the a slurry of solid material and a liquid carrier is injected into the tube. Depending on the need for reinforcement or repair of the tube, a layer of reinforcing material is applied on the exterior of the tube either before or after the tube is positioned on the earth's surface. The reinforcing material may be capable of bonding to the tube in the presence of moisture or be selected from among a group comprising polyurea, polyurea hybrids, polyurethane, polyurethane hybrids and combinations thereof. The reinforcing material may be located on top of a damage area of the tube, which may have been repaired by a mechanical mechanism prior to the application of the reinforcing material. The reinforcing material may also be located along a seam of the tube, which may been closed by a mechanical mechanism prior to the application of the reinforcing material. An example tube may at least one hundred (100) meters long and may have a cross sectional dimension of at least three meters. Also, a primer may be applied on to the tube prior to the reinforcing material, which may facilitate curing or bonding or both of the reinforcing material. Additionally, for UV protection, the reinforcing material may be used to secure a UV shroud to the tube or the reinforcing material may be formulated with pigments or other UV blockers to facilitate UV protection when applied.

In yet another embodiment, an apparatus for preventing erosion of the earth's surface proximate a body of water is disclosed. The apparatus comprises an elongated flexible porous tube injected with a slurry, located on the earth surface proximate the body of water and a layer of reinforcing material on the exterior of the tube. A layer of reinforcing material on the exterior of the tube. The reinforcing material may be capable of bonding to the tube in the presence of moisture or be selected from among a group comprising polyurea, polyurea hybrids, polyurethane, polyurethane hybrids and combinations thereof. The reinforcing material may be located on top of a damage area of the tube, which may have been repaired by a mechanical mechanism prior to the application of the reinforcing material. The reinforcing material may also be located along a seam of the tube, which may been closed by a mechanical mechanism prior to the application of the reinforcing material. Example mechanical mechanisms may be selected from a group comprising staples, nails, and stitching. An example geotextile tube may at least one hundred (100) meters long and has a cross sectional dimension of at least three meters. Also, a primer may be applied on to the tube prior to the reinforcing material, which may facilitate curing or bonding or both of the reinforcing material. Additionally, for UV protection, the reinforcing material may be used to secure a UV shroud to the tube or the reinforcing material may be formulated with pigments or other UV blockers to facilitate UV protection when applied.

In another embodiment, a method of preventing erosion of the earth surface is disclosed. The method comprises applying a layer of reinforcing material on the exterior of an elongated flexible tube of a material, capable of being injected with a slurry of solid material and a liquid carrier, positioning the tube on the earth's surface; and injecting a slurry of solid material and a liquid carrier into the tube.

In an alternate embodiment, a geotextile tube is disclosed. The geotextile tube comprises an elongated flexible tube of a material, capable of being injected with a slurry of solid material and a liquid carrier, and a layer of reinforcing material covering the entire exterior of the tube.

Although only a few exemplary embodiments have been described in detail above, those skilled in the art will readily appreciate that many other modifications are possible in the exemplary embodiments without materially departing from the novel teachings and advantages of this geotextile tube repair and reinforcement method and apparatus. Accordingly, all such modifications are intended to be included within the scope of this geotextile tube repair and reinforcement method and apparatus as described and to which applicants may be entitled.

What is claimed is:

1. A method of repairing geotextile tube, comprising:
locating damaged areas on a geotextile tube,
applying a reinforcing material capable of bonding to the geotextile tube in the presence of moisture, onto the geotextile tube and over the located damaged areas, and
allowing the reinforcing material to cure in place covering the damaged area on the geotextile tube.

2. The method of claim 1, further, comprising:
applying a primer on the geotextile tube prior to applying the reinforcing material.

3. The method of claim 1, wherein the
reinforcing material is selected from among a group comprising polyurea, polyurea hybrids, polyurethane, polyurethane hybrids and combinations thereof.

4. A method of reinforcing geotextile tubes, comprising:
identifying areas on a geotextile tube to be reinforced,
spraying a reinforcing material capable of bonding to the geotextile tube in the presence of moisture onto the geotextile tube and over the identified areas to be reinforced, and
allowing the sprayed reinforcing material to cure in place covering and reinforcing the identified areas on the geotextile tube.

5. The method of claim 5, wherein the reinforcing material is selected from among a group comprising polyurea, polyurea hybrids, polyurethane, polyurethane hybrids and combinations thereof.

6. The method of claim 4, further comprising
spraying a primer on the geotextile tube prior to applying the reinforcing material.

7. The method of claim 4, wherein small cuts and tears are repaired by spraying the reinforcing material directly onto the cut area and letting the reinforcing material cure.

8. The method of claim 4, wherein a large or irregular tear is repaired, further comprising:
pulling together the affected edges of the tear;
mechanically holding the edges of the tear in proximity to each other;
spraying the mechanically held together edges of the tear and the surrounding area of the geotextile tube with the reinforcing material; and
allowing the sprayed material to cure and to form a bonded repair over the tear.

9. The method of claim 8, wherein the mechanically holding the edges of the tear in proximity to each other comprises holding the edges together with fasteners selected from a group comprising staples, nails, and stitching.

10. A method of closing inlet ports of a type having a flange surrounding an opening in a geotextile tube, comprising:
bending the flange inlet port down over the opening in the geotextile tube;
applying a reinforcing material capable of bonding to the geotextile tube in the presence of moisture onto the geotextile tube and over the flange of the inlet port; and
allowing the reinforcing material to cure in place on the geotextile tube and covering the flange thereby sealing the inlet port in the geotextile tube.

11. The method of claim 10, further comprising
applying a primer on the geotextile tube prior to applying the reinforcing material.

12. The method claim 10, wherein the reinforcing material is selected from among a group comprising polyurea, polyurea hybrids, polyurethane, polyurethane hybrids and combinations thereof.

13. The method of claim 10, wherein the flange is of a woven polymeric material.

14. A method of modifying geotextile tubes by adding sand inlet ports comprising:
forming an opening into a geotextile tube, placing an inlet port comprising a tube and a connected flange overlaying the formed opening;
applying a reinforcing material capable of bonding to the geotextile tube in the presence of moisture onto the geotextile tube and over the flange of the inlet port; and
allowing the reinforcing material to cure, in place on the geotextile tube, covering the flange and thereby securing the port tube to the geotextile tube.

15. The method of claim 14, wherein the reinforcing material is selected from among a group comprising polyurea, polyurea hybrids, polyurethane, polyurethane hybrids and combinations thereof.

16. The method of claim 14, wherein the flange is of a woven polymeric material.

17. A method of protecting, repairing, or modifying geotextile tubes or associated UV shrouds and scour aprons, comprising:
applying a reinforcing material, selected from among a group comprising polyurea, polyurea hybrids, polyurethane, polyurethane hybrids and combinations thereof onto areas of the geotextile tube where additional strength, wear resistance or UV protection may be desired so that the sprayed reinforcing material cures bonded to the geotextile tube.

18. The method of claim 17 wherein, reinforcing material is applied by spraying.

19. A method of claim 17, further comprising:
applying a primer on to the geotextile tube, UV shrouds or scour aprons prior to applying the reinforcing material.

20. The method of claim 17, wherein the reinforcing material and the primer are applied by spraying.

21. The method of claim 17, wherein reinforcing material is applied by spraying.

22. The method of claim 17, wherein the geotextile tubes, shrouds and scour aprons are formed of the same woven polymers.

23. The method of claim 17, wherein small cuts and tears are repaired by spraying the selected reinforcing material directly onto the cut area and letting the sprayed reinforcing material cure bonded to the geotextile tube.

24. The method of claim 17, wherein a large or irregular tear is repaired further comprising:
pulling together the affected edges of the tear;
mechanically holding the edges of the tear in proximity to each other;
spraying the mechanically held together area of the tear and geotextile tube with the selected reinforcing material; and
allowing the sprayed reinforcing material to cure to form a bonded repair.

25. The method of claim 17, wherein the mechanically holding the edges of the tear in proximity to each other comprises holding the edges together with fasteners selected from a group comprising staples, nails, and stitching.

26. A method of securing UV shrouds to a geotextile tube, comprising:
applying a reinforcing material capable of bonding to the geotextile tube along a length of an edge of a shroud extended along a length of a geotextile tube; and
allowing the reinforcing material to cure and thereby forming a seam bonding between the geotextile tube and the UV protective shroud.

27. The method of claim 16, wherein the reinforcing material is selected from among a group comprising polyurea, polyurea hybrids, polyurethane, polyurethane hybrids and combinations thereof.

28. A method of providing a UV protection to a geotextile tube, comprising:
specially formulating a reinforcing material capable of bonding to the geotextile tube with appropriate pigments or other UV blockers to facilitate UV protection when applied;
applying the specially formulated reinforcing material onto an area of the geotextile tube for which UV protection is desired; and
allowing the reinforcing material to cure forming a UV protective coating.

29. The method of claim 28, wherein the reinforcing material is selected from among a group comprising polyurea, polyurea hybrids, polyurethane, polyurethane hybrids and combinations thereof.

30. A method of repairing, constructing or reinforcing a seam in a geotextile tube comprising:
spraying a reinforcing material capable of bonding to the geotextile tube along the seam; and
allowing the reinforcing material to cure thereby forming a coating over the seam to repair the seam or to reinforce the seam.

31. A method of claim 30, wherein the reinforcing material is selected from among a group comprising polyurea, polyurea hybrids, polyurethane, polyurethane hybrids and combinations thereof.

32. The method of claim 30, further comprising spraying a primer on to the geotextile tube prior to applying the reinforcing material.

33. A geotextile tube, comprising
an elongated flexible tube of a material, capable of being injected with a slurry of solid material and a liquid carrier, that will allow the liquid carrier to escape through the material leaving the solid material inside of the tube; and
a layer of reinforcing material on the exterior of the tube.

34. The geotextile tube of claim 33, wherein the reinforcing material is capable of bonding to the tube in the presence of moisture.

35. The geotextile tube of claim 33, wherein the reinforcing material is selected from among a group comprising polyurea, polyurea hybrids, polyurethane, polyurethane hybrids and combinations thereof.

36. The geotextile tube of claim 33, wherein the reinforcing material is located on top of a damaged area of the tube.

37. The geotextile tube of claim 36, wherein the damaged area has been repaired by a mechanical mechanism prior to the application of the reinforcing material.

38. The geotextile tube of claim 37, wherein the mechanical mechanism is selected from a group comprising staples, nails, and stitching.

39. The geotextile tube of claim 33, wherein the reinforcing material applied along a seam of the tube.

40. The geotextile tube of claim 39, wherein the seam has been closed by a mechanical mechanism prior to the application of the reinforcing material.

41. The geotextile tube of claim 40, wherein the mechanical mechanism is selected from a group comprising staples, nails, and stitching.

42. The geotextile tube of claim 33, wherein the tube is at least one hundred meters long with a circumference of at least ten meters.

43. The geotextile tube of claim 33, wherein a primer is applied on to the tube prior to the reinforcing material prior to applying the reinforcing material.

44. The geotextile tube of claim 33, additionally comprising:
a UV shroud secured to the tube with the reinforcing material.

45. The geotextile tube of claim 33, wherein the reinforcing material is formulated with pigments or other UV blockers to facilitate UV protection when applied.

46. A method of preventing erosion of the earth surface, comprising:
positioning an elongated flexible tube of a material of the earth surface, capable of being injected with a slurry of solid material and a liquid carrier, that will allow the liquid carrier to escape through the material leaving the solid material inside of the tube;
injecting a slurry of solid material and a liquid carrier into the tube; and
applying a layer of reinforcing material on the exterior of the tube.

47. The method of claim 46, wherein the reinforcing material is capable of bonding to the tube in the presence of moisture.

48. The method of claim 46, wherein the reinforcing material is selected from among a group comprising polyurea, polyurea hybrids, polyurethane, polyurethane hybrids and combinations thereof.

49. The method of claim 46, wherein the reinforcing material located on top of a damage area of the tube.

50. The method of claim 49, wherein the damaged area has been repaired by a mechanical mechanism prior to the application of the reinforcing material.

51. The method of claim 46, wherein the reinforcing material applied along a seam of the tube.

52. The method of claim 46, wherein the tube is at least one hundred meters long with a circumference of at least ten meters.

53. The method of claim 46, wherein a primer is applied on to the tube prior to the reinforcing material prior to applying the reinforcing material.

54. The method of claim 46, additionally comprising:
a UV shroud secured to a tube with the reinforcing material.

55. The method of claim 46, wherein the reinforcing material is formulated with pigments or other UV blockers to facilitate UV protection when applied.

56. An apparatus for preventing erosion of the earth's surface proximate a body of water, comprising;
an elongated flexible porous tube injected with a slurry, located on the earth surface proximate the body of water; and
a layer of reinforcing material on the exterior of the tube.

57. The apparatus of claim 56, wherein the reinforcing material is capable of bonding to the tube in the presence of moisture.

58. The apparatus of claim 56, wherein the reinforcing material is selected from among a group comprising polyurea, polyurea hybrids, polyurethane, polyurethane hybrids and combinations thereof.

59. The apparatus of claim 56, wherein the reinforcing material located on top of a damaged area of the tube.

60. The apparatus of claim 59, wherein the damaged area has been repaired by a mechanical mechanism prior to the application of the reinforcing material.

61. The apparatus of claim 60, wherein the mechanical mechanism is selected from a group comprising staples, nails, and stitching.

62. The apparatus of claim 56, wherein the reinforcing material applied along a seam of the tube.

63. The apparatus of claim 62, wherein the seam has been closed by a mechanical mechanism prior to the application of the reinforcing material.

64. The apparatus of claim 63, wherein the mechanical mechanism is selected from a group comprising staples, nails, and stitching.

65. The apparatus of claim 56, wherein the tube is at least one hundred meters long with a circumference of at least ten meters.

66. The apparatus of claim 56, wherein a primer is applied on to the tube prior to the reinforcing material.

67. The apparatus of claim 56, additionally comprising:
a UV shroud secured to the tube with the reinforcing material.

68. The apparatus of claim 56, wherein the reinforcing material is formulated with pigments or other UV blockers to facilitate UV protection when applied.

69. The apparatus of claim 56, wherein the reinforcing material is applied to the entire surface area of the tube prior to installing the tube on the earth's surface.

70. A method of preventing erosion of the earth surface, comprising:
applying a layer of reinforcing material on the exterior of an elongated flexible tube of a material, capable of being injected with a slurry of solid material and a liquid carrier;
positioning the tube on the earth's surface; and
injecting a slurry of solid material and a liquid carrier into the tube.

71. A geotextile tube, comprising
an elongated flexible tube of a material, capable of being injected with a slurry of solid material and a liquid carrier; and
a layer of reinforcing material covering the entire exterior of the tube.
